(19) United States
(12) Patent Application Publication
(10) Pub. No.: US 2018/0111046 A1
(43) Pub. Date: Apr. 26, 2018

(54) SYSTEMS AND METHODS FOR ENHANCED INTERACTIVITY BETWEEN PHYSICAL TOYS, GAMING CONSOLES, AND/OR SMART DEVICES PARTICIPATING IN A GAMING ENVIRONMENT

(71) Applicant: Performance Designed Products LLC, Burbank, CA (US)

(72) Inventors: Tom Roberts, Apline, CA (US); Scott Terrell, La Mesa, CA (US); Storm Orion, Valencia, CA (US)

(21) Appl. No.: 15/793,932

(22) Filed: Oct. 25, 2017

Related U.S. Application Data
(60) Provisional application No. 62/412,520, filed on Oct. 25, 2016.

(51) Int. Cl. A63F 13/21; A63F 13/235; A63F 13/245; A63F 13/42; A63F 13/95

(52) U.S. Cl. CPC A63F 13/235; A63F 13/21; A63F 13/95; A63F 13/42; A63F 13/245

(57) ABSTRACT

An interactive toy having a housing in the shape of a videogame character and equipped with electronic components including a sensor to detect the toy's orientation and position relative to a gaming zone, and to generate a first signal indicative of the position or orientation. The toy is equipped with a processing engine to receive the first signal and cause a transceiver to transmit a second signal indicative of the orientation or position, and a feedback component to provide an audible sound responsive to the occurrence of a videogame event. The transceiver receives a third signal from the gaming console responsive to a second event occurring in the videogame. The processing engine causes the feedback component to generate an audible sound indicative of an effect of the second event on the videogame character associated with the toy.

### CROSS-REFERENCE

This application claims the benefit under 35 U.S.C. 119 of U.S. Provisional Application 62/412,520, filed on Oct. 25, 2016, which is incorporated herein by reference in its entirety.

### TECHNICAL FIELD

The present disclosure relates generally to gaming technologies, and more particularly some embodiments relate to systems and methods for enhanced interactivity between physical toys, gaming consoles, gaming pads, and/or other smart devices in a gaming environment.

### BACKGROUND OF THE DISCLOSURE

Amidst the overwhelming popularity of traditional video games, tangible toy figurines (often referred to herein as characters) remain a staple among gamers, often serving as the foundation for imaginative toy and game play. Users often play with toy figurines on their own, the figurines serving as a physical extension of the user's own imagination(s). Groups of users may collaborate to play multi-user games, multi-character scene reenactments, or other activities with their toy figurines. The users may move their toy figurines around within the gameplay environment, say or do things as a voice proxy for their toy figurines, or complete other steps with their characters to carry out the game, scene, or other activity with their physical toys in the real-world environment.

In recent years, manufacturers have embedded toy figurines with magnets or passive signatures tags (e.g. RFID tags) to enable at least some level of interaction between the toy figurines and various video gaming consoles. These interactions are often enabled by a gaming portal (sometimes referred to as a base portal) that is connected to the gaming console and configured to detect the toy figurine's magnet or RFID chip when the toy figurine is within a given proximity of the gaming portal, e.g., when the toy is placed on the portal. Using these toy figurines in connection with a gaming portal, the toy figurines may be used to control certain features of a videogame as the videogame being played via the console and a display. By actively moving such toy figurine into certain locations on the base portal, a user may activate or control certain features of the videogame for a more interactive gameplay experience. This genre of gaming has been dubbed “toys-to-life.”

These modern toy characters, though often equipped with magnets and/or RFID tags, are nevertheless limited in their interactive and communication capabilities—both with one another and with the console—and fail to achieve high-level interactions desirable in gaming environments.

### BRIEF SUMMARY OF THE EMBODIMENTS

Some embodiments of the present technology include a toy having a housing in the shape of a videogame character, the housing having an internal cavity enclosing electronic circuitry, the electronic circuitry comprising: a sensor to detect a housing orientation and a housing position relative to a gaming zone, and to generate a first signal indicative of the housing orientation and the housing position relative to the gaming zone; a controller to receive the first signal and cause a transceiver to transmit a second signal indicative of the housing orientation and the housing position; a memory; a feedback component to provide an audible sound responsive to the occurrence of a videogame event; a power source to supply power to the sensor, the processor, the transceiver, the electronic storage medium, and the feedback component; wherein transmission of the second signal causes a first event to occur in a videogame running on the gaming console. In some embodiments, the transceiver is arranged to receive a third signal from the gaming console, the third signal generated by the gaming console responsive to a second event occurring in the videogame, the second event caused by an action of a different videogame character. In some embodiments, the processor causes the feedback component to generate an audible sound indicative of an effect of the second event on the videogame character associated with the toy. In some embodiments, the gaming zone is defined based on a path in space along which the housing moved during a videogame setup procedure, the path in space detected by the sensor and stored in a memory coupled with the housing.

Some embodiments of the present technology include a toy having a toy with: a housing having a surface portion that represents a character of a videogame; a sensor circuit to detect one or more of a housing location relative to a gaming zone and a housing orientation relative to the gaming zone, and to generate a first signal indicative of one or more of the housing location and the housing orientation; a communications circuit to transmit and receive wireless signals between the toy and one or more of a smartphone, a tablet, a gaming console, and a second toy; and a processing engine to interpret the first signal and responsively cause the communication circuit to transmit a second signal indicative of one or more of the housing location and housing orientation to one or more of the smartphone, the tablet, the gaming console, and the second toy. In some embodiments, transmission of the second signal causes a change in an operation of a videogame running on one or more of the smartphone, the tablet, and the gaming console. In some embodiments, the gaming zone is defined based on a path in space along which the housing was moved during a videogame setup procedure, the path in space detected by the sensor circuit and stored in a memory coupled with the housing.

In some embodiments, the communications circuit of the toy receives a third signal from one or more of the smartphone, the tablet, the gaming console, and the second toy, the third signal associated with a videogame event. In some such embodiments, the processing engine is further arranged to cause a feedback component to generate one or more of an audible sound, a visible light, and a haptic vibration responsive to one or more of the first signal, the second signal, and the third signal. In some embodiments, the feedback component is a light-emitting diode, and the light emitting diode changes colors based on a changing game status of the toy.

In some embodiments, the feedback component is a speaker, and the speaker conveys audible messages based on a changing game status of the toy. In some embodiments, the game status of the toy is associated with one or more of the corresponding videogame character's: life, death, punishment, rank, win, loss, points, energy level, earned rewards, achievement, health condition, speed, exposure to danger, and proximity to safety. In some embodiments, the game status of the toy is associated with one or more of the corresponding videogame character's: life, death, punishment, rank, win, loss, points, energy level, earned rewards, achievement, health condition, speed, exposure to danger, and proximity to safety.

In some embodiments, the communications circuit is arranged for radio frequency bidirectional wireless communication. In some embodiments, the communications circuit is arranged for Bluetooth Low Energy bidirectional wireless communication.

In some embodiments, the gaming zone is defined as the user moves the toy along a boundary of the desired gaming zone and the processor responsively causes the locations detected by the sensor circuit to be tracked and recorded in a memory.

Some embodiments of the present technology include a system including: a gaming console; a gaming controller; a plurality of toys, each toy with a housing having a surface portion that represents a character of a videogame; a sensor circuit to detect one or more of a housing location relative to a gaming zone and a housing orientation relative to the gaming zone, and to generate a first signal indicative of one or more of the housing location and the housing orientation; a communications circuit to transmit and receive wireless signals between the toy and one or more of the gaming console, the gaming controller, and other ones of the plurality of toys; and a processing engine to interpret the first signal and responsively cause the communication circuit to transmit a second signal indicative of one or more of the housing location and housing orientation to one or more of the gaming console, the gaming controller, and other ones of the plurality of toys. In some embodiments, transmission of the second signal causes a change in an operation of a videogame running on one or more of the smartphone, the tablet, and the gaming console. In some embodiments, the gaming zone is defined based on a path in space along which the housing was moved during a videogame setup procedure, the path in space detected by the sensor circuit and stored in a memory coupled with the housing.

In some embodiments, the communications circuit is further arranged to receive a third signal from one or more of the gaming console, the gaming controller, and other ones of the plurality of toys. In some embodiments, the processing engine is further arranged to interpret the third signal and cause a feedback component to generate one or more of an audible sound, a visible light, and a haptic vibration responsive to one or more of the first signal, the second signal, and the third signal. In some embodiments, the feedback component is a light-emitting diode, and the light emitting diode changes colors based on a changing game status of the toy. In some embodiments, the feedback component is a speaker, and the speaker conveys audible messages based on a changing game status of the toy.

In some embodiments, the game status of the toy is associated with one or more of the corresponding videogame character's: life, death, punishment, rank, win, loss, points, energy level, earned rewards, achievement, health condition, speed, exposure to danger, and proximity to safety. In some embodiments, the game status of the toy is associated with one or more of the corresponding videogame character's: life, death, punishment, rank, win, loss, points, energy level, earned rewards, achievement, health condition, speed, exposure to danger, and proximity to safety.

In some embodiments, the communications circuit is arranged for radio frequency bidirectional wireless communication. In some embodiments, the communications circuit is arranged for Bluetooth Low Energy bidirectional wireless communication.

In some embodiments, the housing location is one or more of a relative location with respect to a prior location, a geospatial location, a relative location with respect to a base portal, and a relative location with respect to a gaming zone. In some embodiments, the gaming zone is defined as the user moves the toy along a boundary of the desired gaming zone and the processor responsively causes the locations detected by the sensor circuit to be tracked and recorded in a memory.

Some embodiments of the present disclosure include a method including one or more of the steps of: determining a physical condition of a toy based on a movement detected by a sensor circuit physically coupled to the toy, wherein the toy is associated with a videogame character and the physical condition is one or more of a location and an orientation relative to a predefined gaming zone, the information indicative of a changed gaming condition is based on one or more changed physical conditions of other toys participating in the videogame; transmitting, from a communications circuit coupled to the toy, information indicative of the determined physical condition to a gaming console with which the toy is communicatively coupled; receiving, at the communications circuit, information indicative of a changed gaming condition associated with a videogame character associated with the toy, the changed gaming condition based on a videogame event affecting the videogame character; emitting, from a feedback component coupled to the toy, one or more of an audible sound or a visible light responsive to the changed gaming condition. In some embodiments, the information indicative of a changed gaming condition is based on one or more of the videogame character's: life, death, punishment, rank, win, loss, points, energy level, earned rewards, achievement, health condition, speed, exposure to danger, and proximity to safety.

In some embodiments, the gaming zone is not defined by a base portal. In some embodiments, the gaming zone is defined by a path the toy moved along during a videogame setup procedure. In some embodiments, the gaming zone is defined by a boundary that is at least partially based upon a path the toy moved along during a videogame setup procedure.

Some embodiments of the present disclosure include a method including the steps of: determining a physical condition of a toy based on a movement detected by a sensor circuit physically coupled to the toy, wherein the toy is associated with a videogame character and the physical condition is one or more of a location and an orientation relative to a predefined gaming zone; transmitting, from a communications circuit coupled to the toy, information indicative of the determined physical condition to a gaming console with which the toy is communicatively coupled; receiving, at the communications circuit, information indicative of a recommended action to be performed with the toy based on a videogame event associated with a videogame character associated with the toy; emitting, from a feedback component coupled to the toy, one or more of an audible sound or a visible light responsive to communicate the recommended movement to the user. In some embodiments, the recommended action is one or more of a physical displacement of the toy to a location different from its current location, a physical rotation of the toy relative to its current orientation, a physical maneuver of the toy associated with a videogame character maneuver (e.g., a flip, kick, a spin, a trick, a combat move, etc.).

In some embodiments, the method further includes the steps of: detecting, by the sensor circuit physically coupled to the toy, that the recommended action has been performed with the toy; and transmitting, from the communications circuit coupled to the toy, information indicative of the performed action to the gaming console with which the toy is communicatively coupled; wherein a videogame operation is executed based on the transmitted information indicative of the recommended action performed by the toy.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a symbolic depiction of a toy figurine 100 in accordance with one or more embodiments of the present disclosure.

FIG. 2 illustrates an example system and communications environment within which toy figurine 100 may be used for enhanced interactivity with gaming consoles, smart devices, and/or other toy figurines participating in a given game, in accordance with one or more embodiments of the present disclosure.

FIG. 3 illustrates an example gaming environment in accordance with one or more embodiments of the present disclosure.

FIG. 4 illustrates another example gaming environment in accordance with one or more embodiments of the present disclosure.

FIG. 5 illustrates an example method that may be implemented in accordance with one or more embodiments of the present disclosure.

FIG. 6 illustrates an example method that may be implemented in accordance with one or more embodiments of the present disclosure.

FIG. 7 illustrates an example computing module that may be used to implement various features of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION

The present disclosure is directed toward an interactive toy, and systems and methods for implementing and using such interactive toy(s) within a gaming environment.

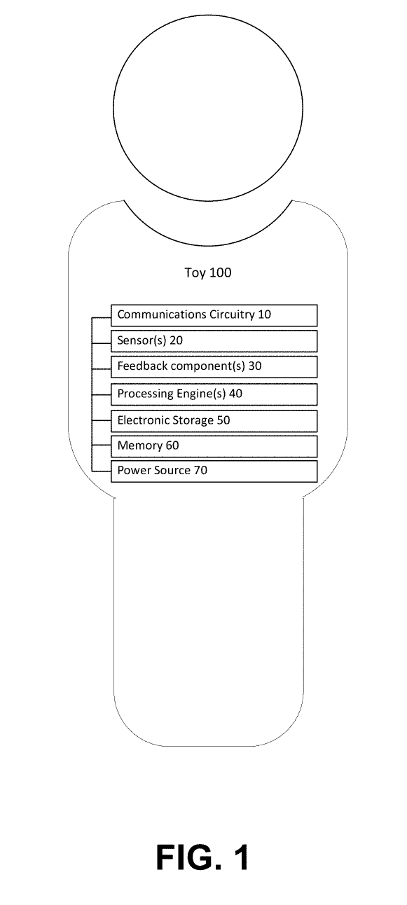

FIG. 1 is a symbolic diagram of an interactive toy in accordance with one or more embodiments of the present disclosure. Interactive toy 100 may include a housing representing any type of physical toy—including toy figurines (e.g., toy characters from popular movies, professional athlete), models (e.g., model cars), and the like—and be configured to carry one or more electrical or electronic components. As shown in FIG. 1, interactive toy 100 may include one or more of communications circuit(s) 10, sensor(s) 20, feedback component(s) 30, processing engine(s) 40, electronic storage 50, memory 60, and/or a power source 70, among other components (e.g. magnetic component, NFC tags, etc.). Each such component may be operatively coupled with any one or more of the other components included in interactive toy 100.

As shown in FIG. 1, interactive toy 100 may include communications circuit(s) 10. Communications circuit(s) 10 may include one or more of transmitter circuit(s), receiver circuit(s), and transceiver circuit(s) facilitating communication between interactive toy 100 and one or more external devices (e.g., a smart device, a gaming console, a computer, other interactive toys, etc.).

Communications circuit(s) 10 may facilitate wired or wireless communication with one or more external devices in accordance with any one or more standard or proprietary protocols/specifications. For example, communication circuit(s) 10 may include a Bluetooth® wireless transceiver configured for communications in accordance with one or more Bluetooth® standards such as Bluetooth® low energy protocols (BLE). Any other one or more communications protocols/specifications may be utilized in various implementations, as one of ordinary skill in the art will appreciate upon reviewing this disclosure, such as any one or more IrDA standards (e.g., IrDA DATA), International Telecommunication Union (ITU) standards (e.g., Home RF SWAP), IEEE-SA standards (e.g. WiFi, or CSMA/CA protocol of IEEE 802.11), cellular or 3GPP standards (e.g., GSM, LTE), WiFi or any other public or private communication protocol.

As shown in FIG. 1, interactive toy 100 may include one or more sensor(s) 20. In some embodiments, sensor(s) 20 may include one or more of movement, proximity, location, level, rotation, inertial, acceleration, and displacement sensor(s) (e.g., accelerometers, gyroscopes, magnets sensors, GPS, altimeters, etc.); temperature sensor(s) (e.g., thermistors, thermocouples, RTDs, ICs, etc.); pressure sensor(s) (e.g., manometers, piezometers, LVDTs, DVRTs, fiber optic pressure sensors, electronic pressure sensors, etc.); image sensors (e.g., CMOS, CCD, other photodetectors, etc.), touch sensor(s) (capacitive touch sensors, resistive touch sensors, etc.), audio sensors (e.g., microphones, etc.), and/or any other type of sensor. Sensors such as accelerometers, gyroscopes and/or magnetic sensors may sense certain motions or movements of interactive toy 100 (e.g., when the user moves interactive toy 100 to a different position, for instance to indicate or enable advancement to a “next level”; or when interactive toy 100 is tipped over or laid down, for instance to indicate that a player is dead or out of the game).

Signals generated by the one or more sensor(s) 20 may be received by the one or more processor(s), which in turn may execute one or more computer program instructions causing communications circuit(s) 10 of interactive toy 100 to communicate information to one or more external device(s) in the gaming environment. Such information may be used as an input or command to one or more external device(s) such that the toy itself may be used to control or otherwise provide input into the gaming environment.

For instance, a user may move an interactive toy 100 out of a physical zone corresponding to a holding cell in the game, interactive toy 100 may detect and communicate movement information to a gaming console hosting the corresponding videogame. Computer program instructions being executed at the gaming console may interpret this movement information as being associated with the a release from the holding cell, and accordingly cause the character in the videogame that is associated with interactive toy 100 to be released from the holding cell for further participation in the videogame.

For instance, a user may move an interactive toy 100 athlete out of a physical zone corresponding to a courtside bench in a basketball game, and onto a physical zone corresponding to the court in the game. Interactive toy 100 may detect and communicate such movement information to a gaming console hosting the corresponding videogame. Computer program instructions being executed at the gaming console may interpret this movement information as being associated with being taken off of the bench and put onto the court for playing the basketball game, and accordingly cause the character in the videogame that is associated with interactive toy 100 to be taken off the “bench” and put on the “court” for further participation in the videogame.

Interactive toy 100 movements (or other manipulation) may effectuate a change in the gaming functions caused by the input buttons of a connected videogame controller (e.g., Xbox One controller, PS4 handheld controller, etc.). For instance, suppose a user is playing combat based game with the objective of fighting villains on each level to progress to the next. Further suppose the user is provided with two toys representing two characters they can use, one-at-a-time, to fight the villains and pass the various levels in the game. Suppose that the first toy character that by default is equipped with a sniper rifle with ten bullets, and a second toy character that by default is trained in hand-to-hand combat but has a depletable amount of energy. In accordance with computer program instructions, characters in zone A are in-play while characters in zone B are out-of-play. On a first level where the challenging villain is easy to beat in hand-to-hand combat, the user may move the second toy into zone A at the outset and then use their videogame controller to operate the character in the videogame in a hand-to-hand combat exchange with the villain. Having passed the first level, the user may progress to a second level. On the second level the user may face a large monstrous villain for which hand-to-hand combat would be almost certainly unsuccessful (or would almost completely deplete the energy of the character associated with the second toy). Thus, to preserve the energy level of the character associated with the second toy, the user may move the second toy into zone B, and move the first toy into zone A. Computer program instructions being executed at the gaming console may interpret this movement information and effectuate a change in the character in play such that the character associated with the first toy (the character that by default is equipped with a sniper rifle with 10 bullets) becomes the character controllable via the input mechanisms of the videogame controller. Consequently, the user may manipulate input mechanisms of the videogame controller corresponding to aiming and shooting the sniper rifle, and thereby shoot the monstrous villain of level 2 in order to progress to level 3. The user may thus utilize the tangible toy figurines to interchange which videogame character is in-play at a given moment, with the gaming console seamlessly adjusting what videogame functionality is executed responsive to the manipulation of input mechanisms on the videogame controller. The foregoing is just one example of how the toy figurines of the present disclosure may be utilized to enhance a user's videogame experience within a videogame environment. One of ordinary skill in the art will appreciate upon review of the instant disclosure that the toy figurines disclosed herein may be utilized in any other manner to effectuate a control or change within the gaming environment.

For instance, by way of another example, a user may reach a particular point in their videogame experience, and be prompted by the videogame to perform a certain move or act with a corresponding figuring (interactive toy 100) before they can move to the next level (or achieve any other objective relevant to the game). The user may then perform the move or act with the corresponding toy—where the move or act may be sensed by sensor(s) 20 of interactive toy 100 and communicated back to the gaming console via communications circuit(s) 10 of interactive toy 100—and the videogame may respond accordingly (e.g., allow the user to move to the next level).

One of ordinary skill in the art will appreciate that, on account of the robust communication between and among interactive toy 100 and external devices (e.g., smart devices, gaming consoles, other toys, etc.), interactive toy 100 may be utilized at a higher level of interactivity within the gaming environment. Also, because interactive toy 100 is equipped with electronic storage 50, information and statistics about interactive toy 100 and/or about the corresponding character in the videogame may be stored and saved for later reference or use (e.g., information that is intended to carry over from one gaming session to another, or to follow the character for a certain period of time). Examples of the types of information that might be stored in electronic storage 50 include: current or past locations, experiences, statistics, levels completed, rank achieved, tools or other weapons collected or lost, points or currency scored or earned, skills mastered, injuries sustained, highest/lowest/average/median scores obtained, combat statistics (e.g., 90% win rate against a particular opponent, etc.), alliances developed with other toy characters, secrets between a given toy character and one or more other toy characters, and/or any other data, information, characteristic, attribute, achievement, place marker (e.g., of character when game was interrupted), or any other condition that is relevant to the game and associated with the character and/or interactive toy 100 under consideration.

Sensor(s) 20 of interactive toy 100 may include any one or more sensors of any other type, as noted, including but not limited to sensors configured to detect motion, movement, proximity (e.g. to another object), light, electromagnetic radiation, rotation, magnetic fields, touch, sound, force, pressure, heat, temperature, and the like. Conditions detected by any one or more of such sensors may be recorded or otherwise stored in electronic storage 50, communicated to one or more external source(s) via communications circuit(s) 10, used to determine whether and/or how to activate feedback component(s) 30 (discussed in more detail below) to provide an indication or notification to the user, or for any other purpose relevant to the game itself or the user's gaming experience.

As shown in FIG. 1, interactive toy 100 may include one or more feedback components 30. Feedback components 30 may be operatively coupled with one or more of the other components carried by interactive toy 100, and be triggered by one or more of them to provide an alert or an indication to a user. Feedback component(s) 30 may include any one or more visual (e.g., a light source, a display), haptic (e.g., a vibration motor, solenoid tap), acoustic (e.g., a speaker) or other feedback device that, in operation, may trigger a user's sensory faculties to provide a notification or alert. Feedback component(s) 30 may be configured to provide an indication to the user (i.e., feedback) based on or responsive to signals or information from one or more of a connected gaming console, a connected videogame controller, another toy, or any one or more components of interactive toy 100 itself, including but not limited to information received by communications circuit(s) 10, information gleaned from sensors 20, information stored in electronic storage 50 or memory 60 of interactive toy 100 itself or analogous components of another toy participating in the same or related game as interactive toy 100, and/or any other information based on any combination of the foregoing.

For instance, an LED light based feedback component 30 may blink a predetermined number of times, or in a particular pattern or color to provide a notification/alert to the user about interactive toy 100. For example, an LED feedback component 30 may emit a constant green light indicating the gaming character associated with interactive toy 100 is still “alive,” “in-play,” or “available to be placed in-play,” and the light may turn red when the gaming character associated with interactive toy 100 is “dead,” “out of play,” or “should be taken out of play,” for example. For instance, an LED feedback component 30 may turn from green to red when the sensors 20 detect that the player has been physically knocked down (or moved, or any other pre-defined condition of the game), or, the communications circuit(s) 10 receives information from an external device (e.g. a gaming console) that the videogame character is now out-of-play or should be taken out-of-play (e.g., if the character lost the race, has been fatally wounded, fouled out, been imprisoned, or any other condition of the game).

In another example, the feedback component 30 may include a speaker. Upon a condition being met or criteria satisfied, the speaker may emit a sound associated with an alert or event (e.g., a beep, pattern of beeps, a crash sound, etc.), or may emit audio relaying a message (e.g. “finish him off,” “touchdown!,” “five, four, three, two, one, go!”, etc.) that may be heard by a nearby user. Such a speaker may also be utilized in combination with a microphone as a mechanism for real-time communication as between player's in remote locations.

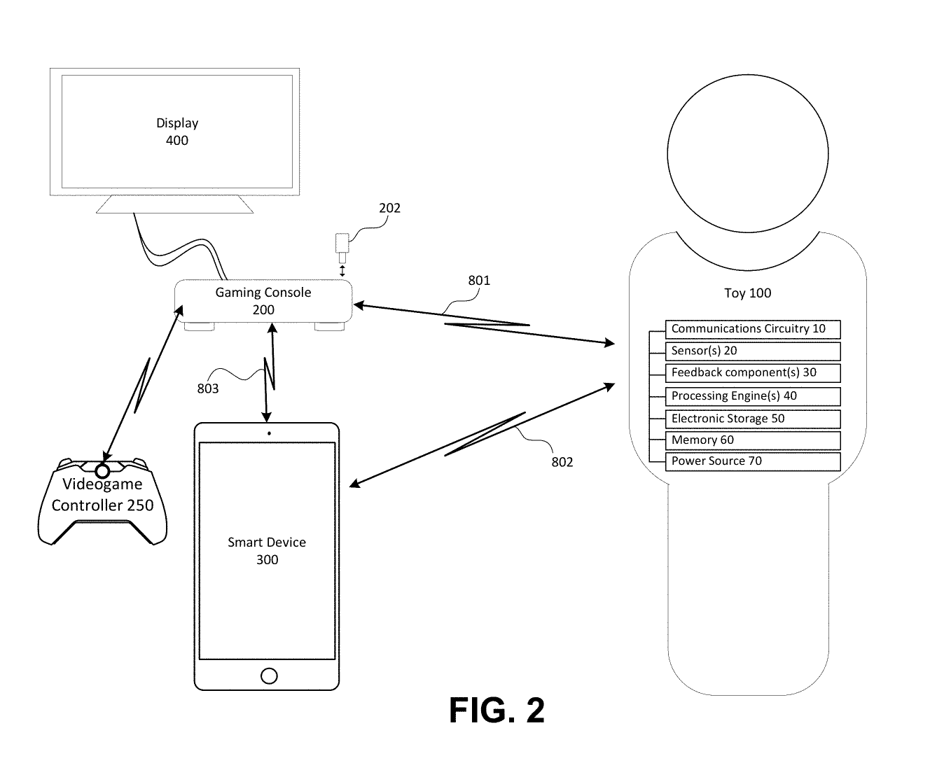

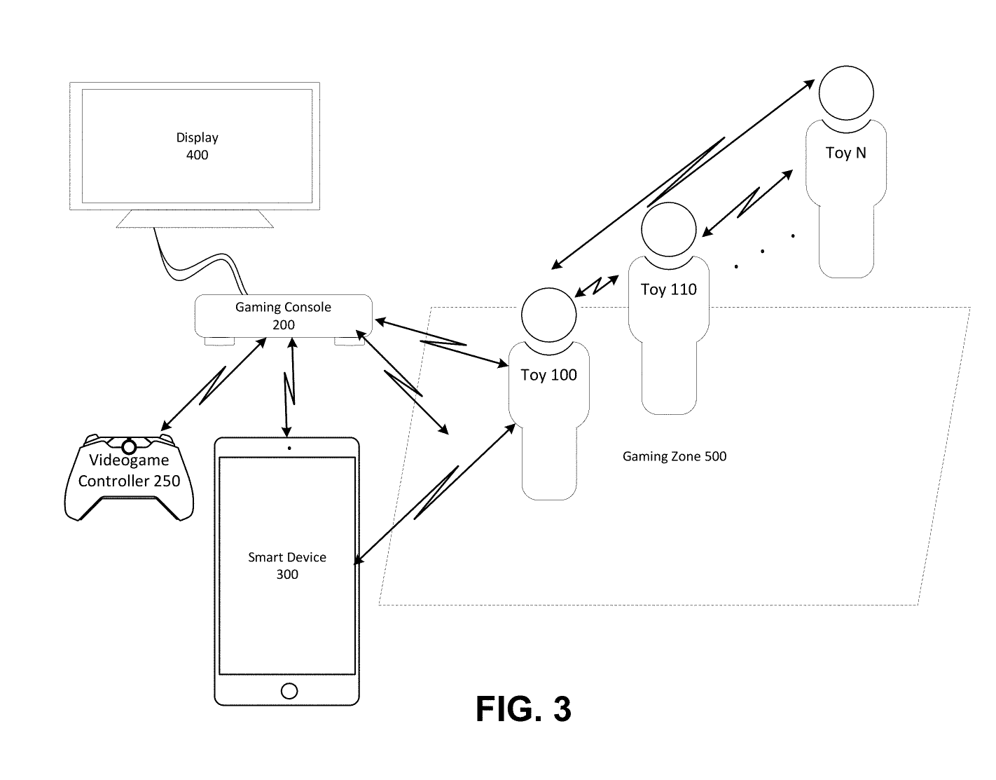

Further examples will be discussed with reference to FIGS. 2 and 3. One of ordinary skill in the art should appreciate that these examples are provided to facilitate the reader's understanding of the disclosed technology, and are not intended to be limiting of the breadth, scope, or applicability of the technology described herein. For instance, while LED and speaker type feedback components are discussed in the examples above, any type of feedback component 30 may be implemented to provide any type of feedback desired for a given game or given implementation. Such feedback may be provided to convey information about interactive toy 100 itself (e.g., low battery, etc.), its status in a game (e.g., dead, out-of-play, in-the-lead, winner, etc.), any other condition or situation relevant the game the toy is involved in (e.g., game over, 20% character energy depletion, etc.), or even information/messages/voice from another player interacting with the videogame.

As shown in FIG. 1, interactive toy 100 may include one or more processing engine(s) 40. Processing engine(s) 40 may be operatively coupled with any one or more of the other components of Interactive toy 100. In some embodiments, processing engine(s) 40 may execute one or more operations in connection with the other components of interactive toy 100 (with which it/they is/are operatively coupled) based on information received from (or generated by) sensor(s) 20. For example, processing engine(s) 40 may cause communication signals to be transmitted via communication circuit(s) 10 based on information generated by one or more sensor(s) 20 in response to a sensor triggering event (e.g. movement, rotation, imposed force, etc.). The signals transmitted may provide relevant information about interactive toy 100 or the toy's environment to an external device (e.g., a gaming console), where the information provided may be based on what the sensors 20 detected. By way of a few nonlimiting examples, the information provided may indicate interactive toy 100 is present and in an “in-play” zone ready to play a game; or, interactive toy 100 was knocked down by another player and is now “defeated” or “out-of-play” for a certain period; or, the toy has been physically moved and therefore the simulated character in the videogame corresponding to interactive toy 100 should move in a similar fashion; or any other information relevant to the game.

Processors 40 may effectuate the storage of information in electronic storage 50 and/or memory 60 based on information received from an external device (e.g., smartphone, a gaming console, a cloud resource such as a gaming database, another toy, etc.), information obtained from one of the sensor(s) 20 (including information determined based on signals received from one of the sensor(s) 20) or other components of interactive toy 100. As noted, some non-limiting examples of the types of information that may be stored in electronic storage 50 include: current or past locations, experiences, statistics, levels completed, rank achieved, tools or other weapons collected or lost, points or currency scored or earned, skills mastered, injuries sustained, highest/lowest/average/median scores obtained, combat statistics (e.g., 90% win rate against a particular opponent, etc.), alliances developed with other toy characters, secrets between a given toy character and one or more other toy characters, and/or any other data, information, characteristic, attribute, achievement, place marker (e.g., of character when game was interrupted), or any other condition that is relevant to the game and associated with the character and/or interactive toy 100 under consideration. Any one or more of processing engine(s) 40 and sensor(s) 20 may alone or together actuate one or more feedback component(s) in any manner, including as described herein, based on any such information.

The foregoing examples are not intended to be limiting, and one of ordinary skill in the art will appreciate that toys of the present disclosure may be equipped to sense any information in the physical or virtual environment associated with interactive toy 100 (e.g., via sensor(s) 20), process such information (e.g., via processing engine(s) 40), store such information (e.g., via one or more of electronic storage 50 or memory 60), transmit or receive information to/from external devices such as gaming consoles, smartphones, and other toys (e.g., via communications circuit(s) 10), effectuate changes in the videogame based on transmission of information obtained (e.g., transmitting signals to a gaming console causing the gaming console to complete a videogame operation it would not otherwise complete at a given moment absent reception of the transmitted signals), provide feedback to a user responsive to such information (e.g., via feedback component(s) 30), and facilitate voice communications between users in different physical locations (e.g., via microphone, speaker, and communications circuits of user's respective toys), in accordance with embodiments of the present technology.

As shown in FIG. 1, interactive toy 100 may include a power source 70. The power source 70 may be arranged to provide power to any one or more of the other components of interactive toy 100, including those components shown in FIG. 1. Power source 70 may include one or more of a battery, a plug or port that may be coupled to an AC or DC power supply, or any other power source known in the art, or any other variation or modification of such power sources (e.g., interactive toy 100 may include photovoltaic cells that provide power to one or more of the other interactive toy 100 components).

FIG. 2 depicts an exemplary system and communications environment within which interactive toy 100 may be used for enhanced interactivity with gaming consoles, smart devices, and/or other toys participating in a game. As shown, system may include an interactive toy 100, a gaming console 200, a smart device 300 (e.g., smartphone (shown), videogame controller (not shown)), and a display 400, one or more of which may be in operative communication with one another via one or more communications links 801-803. As noted, communication with Interactive toy 100 (via communications circuit(s) 10 over links 801 and/or 802) may occur using Bluetooth connectivity (e.g., Bluetooth® LE connectivity), or any other robust communications protocols capable of communicating data, including bidirectional communication connectivity protocols (Wi-Fi, ZigBee, etc.). Any one or more of links 801-803 may be wired or wireless, or capable of both.

Gaming console 200 may be any type of gaming console. For example, gaming console may include an Xbox®, a PlayStation®, a Nintendo® gaming console, and the like. Gaming console 200 may be configured to receive and transmit information in accordance with the protocols employed by the communication circuit(s) 10 of interactive toy 100. In some embodiments, gaming console 200 may be configured with appropriate communications circuits internally, and in other embodiments and additional component (e.g., a dongle) may be coupled with the gaming console to achieve proper communication with interactive toy 100. For example, if interactive toy 100 is configured to communicate using Bluetooth® LE standards, but the native gaming console does not include Bluetooth connectivity capabilities, a Bluetooth® LE enabled dongle 202 may be connected to (e.g., plugged into) gaming console 200 to this establish a line of communication with interactive toy 100.

Smart Device 300 may be any type of smart device. For example, smart device may be an Android® based smartphone/tablet, an iOS® based smartphone/tablet, a smartwatch, and the like. For purposes of this disclosure, smart device may also refer to a videogame controller such as a handheld PS4 controller, a handheld Xbox One controller, and the like. Smart device 300 may be configured to receive and transmit information in accordance with the protocols employed by the communication circuitry 10 of interactive toy 100 or gaming console 200, and vice-versa. In some embodiments, the smart device 300 may be configured with internal communications circuits. In other embodiments an additional component (e.g. a dongle) may be plugged into or otherwise coupled with the smart device to achieve proper communication with either interactive toy 100 or gaming console 200. In some embodiments, smart device 300 communicates with one or more of interactive toy 100 and gaming console 200 using Bluetooth® LE protocols. In some embodiments, the communication standards employed to establish communication between the gaming console 200, the smart device 300, and interactive toy 100 are all based on the same communications standard (e.g., a Bluetooth LE standard). In other embodiments, the communications standards him employed to establish communication between the gaming console 200, the smart device 300, and interactive toy 100 are based on different communications standards. By way of a nonlimiting example, interactive toy 100 may communicate with gaming console 200 and smart device 300 using Bluetooth® LE, while smart device 300 and gaming console 200 may communicate over a Wi-Fi connection. In some embodiments, such communications may occur sequentially or simultaneously.

As shown in FIG. 2, a user may enjoy connectivity and enhanced interactivity in a gaming environment via communications between a gaming console 200 running their video game (e.g. Xbox®, PlayStation®, etc.), one or more smart device(s) 300 (e.g. Android based smartphone/tablet, iOS based smartphone/tablet, a smartwatch, an XBox videogame controller, a PS4 videogame controller, etc.) and an interactive toy 100.

For example, interactive toy 100's sensor(s) 20 may detect a condition or occurrence in connection with interactive toy 100, and generate information indicative of that condition and communicate that information to the gaming console 200 over link 801 (e.g., Bluetooth connection, WiFi connection, etc.), or to smart device(s) 300 over link 802. interactive toy 100 may also have data stored in electronic storage 50, e.g., a record of actions or statistics about interactive toy 100 (or a gaming character associated with interactive toy 100). Such information may also be communicated from interactive toy 100 to gaming console 200 over link 801 (e.g., Bluetooth connection, WiFi connection, etc.), or to the smart device(s) 300 over link 802 (e.g., Bluetooth connection, WiFi connection, etc.).

Information may flow from the gaming console 200 to interactive toy 100, or vice versa, and be stored in a memory or electronic storage of either location. For example, while a user is playing a videogame involving a character corresponding to interactive toy 100, the user may achieve a certain number of points, earn a reward (e.g., a new weapon, an upgraded car, etc.), and this information may be transmitted via communications link 801 to interactive toy 100. Interactive toy 100 may receive the information via communications circuit(s) 10, and use the information for any purpose. For example, interactive toy 100 may record/store the information in electronic storage 50 (to be referenced or used at another time or in another place), may provide feedback to the user via one or more feedback component(s) 30 (e.g., emit a sound indicating to the user to knock the toy over, or move it to a different location, emit a light indicating to the user that interactive toy 100's energy is depleted to a certain degree, etc.).

Similarly, information may flow from the smart device 300 to interactive toy 100. In this way, interactive toy 100 may utilize other sensory features available in the smart device 300 that may or may not be included in interactive toy 100. For example, GPS or other location data from the smart device 300 may be provided to interactive toy 100 for a purpose designated in a game. For instance, if the videogame involves a baseball game, and the user may be awarded additional points for actually attending the baseball game for the team that his interactive toy 100 is associated with, the user's smartphone may detect (using GPS) that he was located in the baseball stadium during a scheduled game, and transmit such information to interactive toy 100 via communications link 802, and the toy may receive and/or record the information and be awarded the necessary points in the context of the game.

Information detected and/or generated by any one or more of the aforementioned devices (e.g., interactive toy(s) 100, gaming console(s) 200, and/or smart device(s) 300) may be communicated to and stored in a memory location (e.g., memory 60, electronic storage 50) of any one or more of the other devices. Moreover, such information detected and/or generated by anyone or more of the aforementioned devices may be communicated to a remote resource such as a server farm or cloud-based data center for later access and use. Upload and download of such information from such remote sources may occur using any communications protocols, including any discussed herein (e.g., Bluetooth, Wi-Fi, Zigbee, cellular, etc.) as well as any others known in the art or which may become known in the art.

FIG. 3 illustrates an example gaming environment in accordance with one or more embodiments of the present disclosure, including a plurality of toy figurines that may be interactively connected in a mesh network in accordance with one or more embodiments of the present disclosure. As shown, a plurality of toys (e.g., interactive toy 100, toy 110, . . . toy N) may be interactively connected with one another in accordance with the present disclosure. Each of the toys 100 in such an environment may be connected in accordance with any communications protocol, including but not limited to Bluetooth® LE. In some embodiments, the toys communicate with one another via Bluetooth advertising packets and scanning mechanisms (e.g., via communication circuitry 10). In some embodiments, there is no master/servant relationship between the figurines, while in other embodiments there may be a master/servant relationship (e.g., where one interactive toy operates as the primary, or master). In some embodiments, such interactive toys may operate and interact with one another while remaining independent from the control of any other interactive toy in the network. In some embodiments, one or more interactive toys may exercise control over one or more other interactive toys in the network.

The presently disclosed technology may be arranged to engage in communication with remote sources to further enhance interactivity. For instance, multiple toys may be able to interact over long distances via interconnectivity between gaming systems over a cloud-based network. Accordingly, the technology of the present disclosure expands the distance over which toys (e.g., interactive toy 100) may interact with other such toys to any distance desirable for a particular game environment. In this way, multiple users in remote locations from one another may engage in a game with one another using their individual toys 100 to effectuate functionality or changes in the game the two are playing. Current toys do not allow for this.

The disclosed technology therefore provides users with additional mechanisms to control, interact with, or otherwise engage in a gaming environment. A player may use a traditional videogame controller connected to a gaming console (e.g., Xbox®, PlayStation®, etc.), and/or use a separate smart device (e.g., an Android based smartphone/tablet, an iOS based smartphone/tablet, etc.), and/or use toy figurines of the present disclosure which may represent one or more characters relevant to a given game (e.g., professional athlete figurines, superhero figurines, automobile figurines, custom designed action character figurines, etc.). In accordance with the presently disclosed technology any one or more of the foregoing mechanisms may be used, either alone or in an interactive mesh network with many other mechanisms, e.g., a plurality of toys in an interactive mesh network with one another. The present technology allows a user to further enjoy a given game at a higher level of interactivity and with enhanced responsive capacity.

As further shown in FIG. 3, gaming environment may include a gaming zone 500. Gaming zone 500 may be a predefined space within which interactive toys of the present disclosure may operate, and relative to which determinations about an interactive toy 100's location, orientation, or other physical condition may be made. In some embodiments movements or other physical conditions that the sensor(s) 20 detect are based upon or relative to, in whole or in part, the gaming zone 500. Gaming zone 500 may include a predefined or user definable coordinate system such that determinations about an interactive toy 100s location, orientation, or other physical condition that is made relative to the gaming zone may be computed or estimated within the context of the gaming zone 500's coordinate system such that gaming console 200 may associate detected changes in location, orientation, or other physical condition with the proper corresponding operation or functionality within the context of the videogame being played. In some embodiments, interactive toy 100 may be used to define the boundaries or other parameters of the gaming zone 500. For example, during a set up procedure associated with a particular videogame, series of video games, or videogame platform, a user may be prompted to move an interactive toy 100 along a path to define the border of the users desired gaming zone 500. Sensors 20 within interactive toy 100 may detect interactive toy 100s position(s) as the user moves the toy along the desired path, and communicate information representing such positions to the gaming console, or any other external device or external resource. Such information may also be stored in a memory 60 of interactive toy 100. In this manner, a user may avoid the need to use a base portal (upon which conventional toys must be placed to participate in a game), and may instead define their own space upon which to play, that is gaming zone 500.

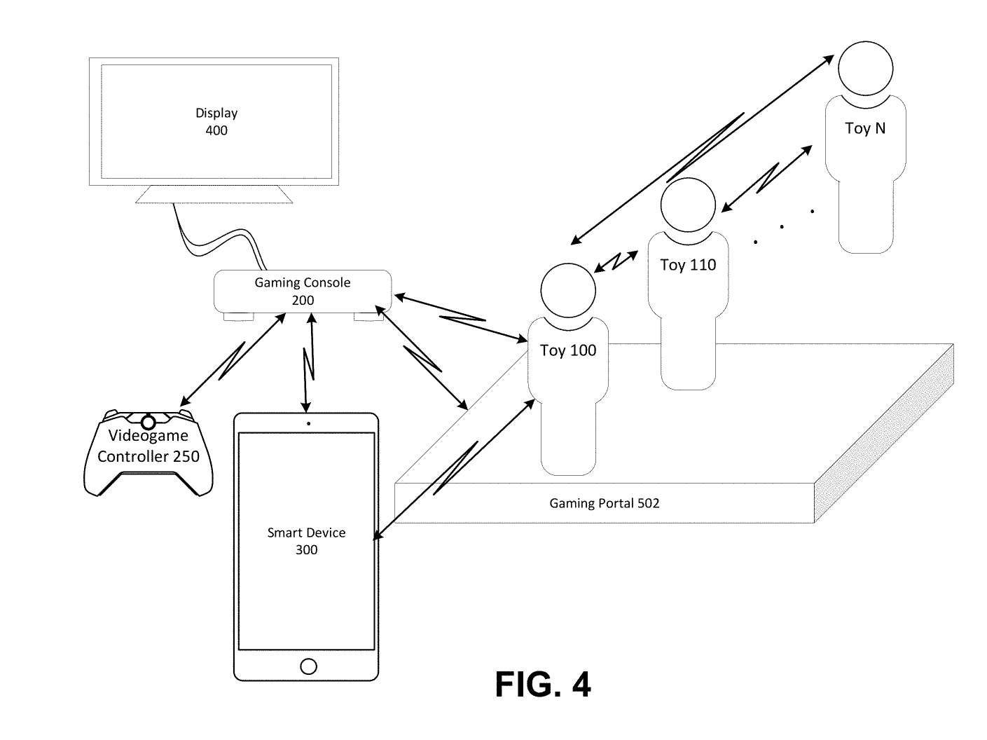

Though a player may utilize interactive toy 100 of the present disclosure to define a custom gaming zone 500, it should be understood that the interactive toys 100 may in some embodiments be used with a gaming portal 502, as shown in FIG. 4. In such embodiments, a player may use a gaming portal 502 as the gaming zone 500. With reference to FIG. 3 and FIG. 4, it should be appreciated by one of ordinary skill in the art that the interactive toys 100 of the present disclosure may be used in environments that include a gaming portal 502, or that do not include a gaming portal. In embodiments that do not utilize a gaming portal, a gaming zone 500 may be utilized, whether predefined or defined by the player by moving their interactive toy 100 as noted above, for example. It should further be understood that in some embodiments, neither a gaming portal 502 nor a predefined gaming zone 500 may be used. That is in some implementations, interactive toy 100 may interact with and control a given videogame based upon a change in the interactive toy 100's physical condition (e.g., a change in location relative to a prior location, a change in orientation relative to a prior orientation, and the like). In still further embodiments, interactive toy 100 may interact with and control a given videogame based upon toy 100s physical condition relative to the global coordinate system (e.g., a GPS location of interactive toy 100, or change thereto; a cardinal direction interactive toy 100 is facing a given moment, etc.).

FIG. 4 illustrates a pictorial diagram showing an exemplary gaming environment in accordance with one or more embodiments of the present disclosure. As shown, in some embodiments interactive toy 100 may communicate with and control a videogame being run on gaming console 200. In some embodiments interactive toy 100 may communicate with smart device 300 (e.g., smartphone), a gaming portal 502 (discussed above), a gaming console 200, or any other external device. Smart device 300 may collect or track information associated with interactive toy 100. As noted above, such information may include, for example, current or past locations, experiences, statistics, levels completed, rank achieved, tools or other weapons collected or lost, points or currency scored or earned, skills mastered, injuries sustained, highest/lowest/average/median scores obtained, combat statistics (e.g., 90% win rate against a particular opponent, etc.), alliances developed with other toy characters, secrets between a given toy character and one or more other toy characters, and/or any other data, information, characteristic, attribute, achievement, place marker (e.g., of character when game was interrupted), or any other condition that is relevant to the game and associated with the character and/or interactive toy 100 under consideration.

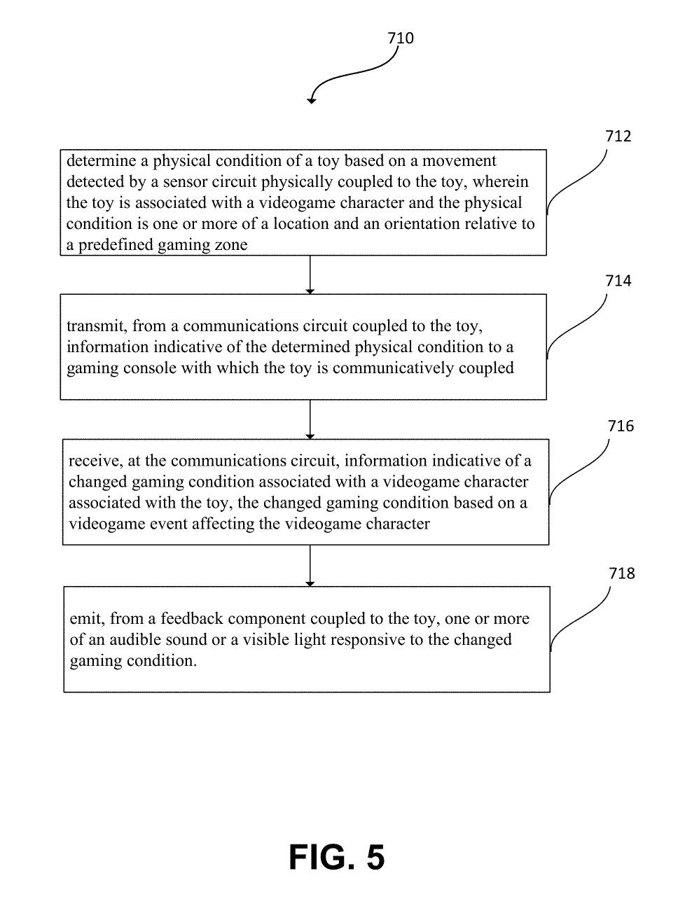

FIG. 5 illustrates an example method 710 that may be implemented in accordance with one or more embodiments of the present disclosure. Method 710 may comprise one or more of steps 712-718. As shown, at operation 712 method 710 determines a physical condition of a toy based on a movement detected by a sensor circuit physically coupled to the toy, wherein the toy is associated with a videogame character and the physical condition is one or more of a location and an orientation relative to a predefined gaming zone. At operation 714, method 710 transmits, from a communications circuit coupled to the toy, information indicative of the determined physical condition to a gaming console with which the toy is communicatively coupled. At operation 716, method 710 receives, at the communications circuit, information indicative of a changed gaming condition associated with a videogame character associated with the toy, the changed gaming condition based on a videogame event affecting the videogame character. At operation 718, method 710 emits, from a feedback component coupled to the toy, one or more of an audible sound or a visible light responsive to the changed gaming condition.

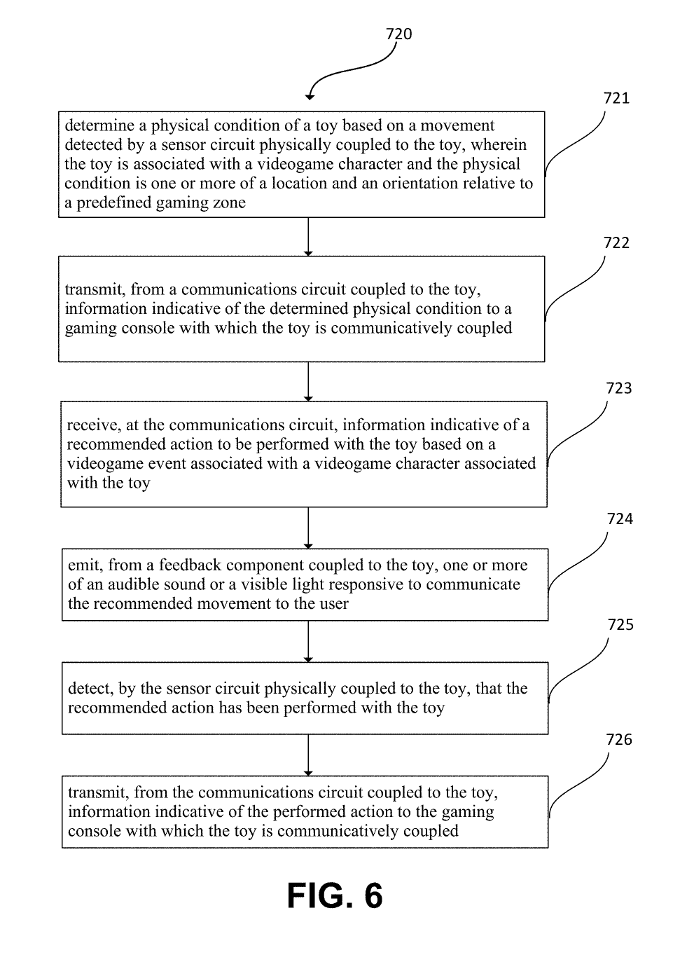

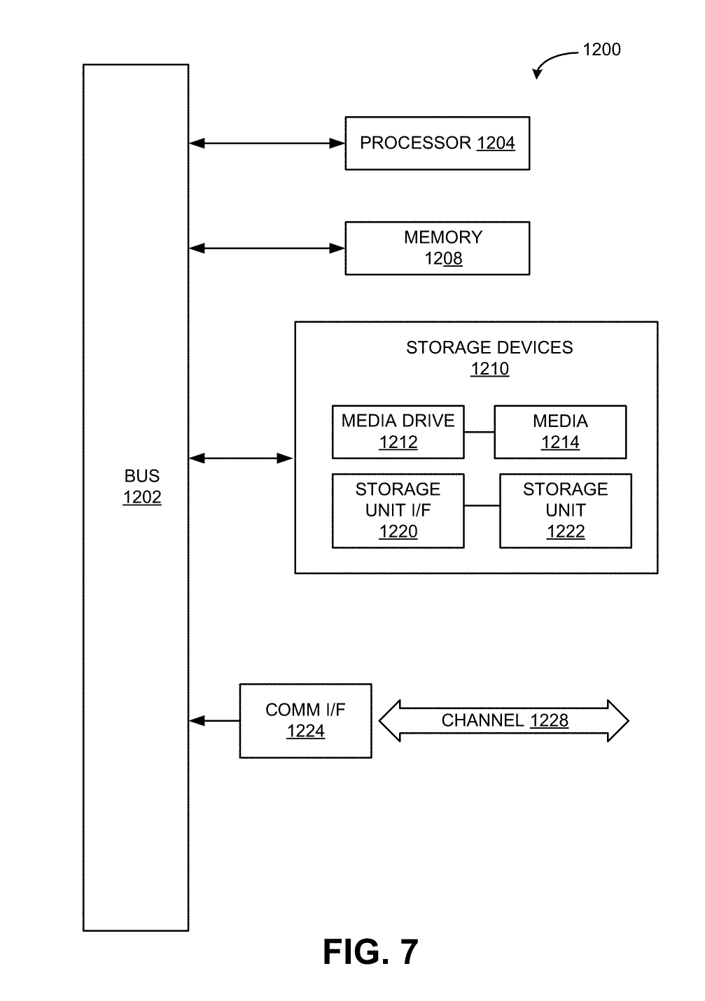

FIG. 6 illustrates an example method 720 that may be implemented in accordance with one or more embodiments of the present disclosure. Method 720 may comprise one or more of steps 721-726. At operation 721, method 720 determines a physical condition of a toy based on a movement detected by a sensor circuit physically coupled to the toy, wherein the toy is associated with a videogame character and the physical condition is one or more of a location and an orientation relative to a predefined gaming zone. At operation 722, method 720 transmits, from a communications circuit coupled to the toy, information indicative of the determined physical condition to a gaming console with which the toy is communicatively coupled. At operation 723, method 720 receives, at the communications circuit, information indicative of a recommended action to be performed with the toy based on a videogame event associated with a videogame character associated with the toy. At operation 724, method 720 emits, from a feedback component coupled to the toy, one or more of an audible sound or a visible light responsive to communicate the recommended movement to the user. At operation 725, method 720 detects, by the sensor circuit physically coupled to the toy, that the recommended action has been performed with the toy. Operation 726, method 720 transmits, from the communications circuit coupled to the toy, information indicative of the performed action to the gaming console with which the toy is communicatively coupled.

Where components or modules of the application are implemented in whole or in part using software, in one embodiment, these software elements can be implemented to operate with a computing or processing module capable of carrying out the functionality described with respect thereto. One such example computing module is shown in FIG. 7. FIG. 7 illustrates an example computing module 1200 that may be used to implement various features of the systems and methods for transmitting data between a remote device and a computing device as disclosed herein. Various embodiments are described in terms of this example-computing module 1200. After reading this description, it will become apparent to a person skilled in the relevant art how to implement the application using other computing modules or architectures.

Computing module 1200 may represent, for example, computing or processing capabilities found within desktop, laptop, notebook, and tablet computers; hand-held computing devices (tablets, PDA's, smart phones, cell phones, palmtops, etc.); wearable computing devices such as smartwatches; mainframes, supercomputers, workstations or servers; or any other type of special-purpose or general-purpose computing devices as may be desirable or appropriate for a given application or environment. Computing module 1200 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality. In the illustrated example, processor 1204 is connected to a bus 1202, although any communication medium can be used to facilitate interaction with other components of computing module 1200 or to communicate externally.

Computing module 1200 might also include one or more memory modules, simply referred to herein as main memory 1208. For example, preferably random access memory (RAM) or other dynamic memory, might be used for storing information and instructions to be executed by processor 1204. Main memory 1208 might also be used for storing temporary variables or other intermediate information during execution of instructions to be executed by processor 1204. Computing module 1200 might likewise include a read only memory (“ROM”) or other static storage device coupled to bus 1202 for storing static information and instructions for processor 1204.

The computing module 1200 might also include one or more various forms of information storage mechanism 1210, which might include, for example, a media drive 1212 and a storage unit interface 1220. The media drive 1212 might include a drive or other mechanism to support fixed or removable storage media 1214. For example, a hard disk drive, a solid state drive, a magnetic tape drive, an optical disk drive, a CD, DVD, or Blu-ray drive (R or RW), or other removable or fixed media drive might be provided. Accordingly, storage media 1214 might include, for example, a hard disk, a solid state drive, magnetic tape, cartridge, optical disk, a CD, DVD, Blu-ray or other fixed or removable medium that is read by, written to or accessed by media drive 1212. As these examples illustrate, the storage media 1214 can include a computer usable storage medium having stored therein computer software or data.

In alternative embodiments, information storage mechanism 1210 might include other similar instrumentalities for allowing computer programs or other instructions or data to be loaded into computing module 1200. Such instrumentalities might include, for example, a fixed or removable storage unit 1222 and an interface 1220. Examples of such storage units 1222 and interfaces 1220 can include a program cartridge and cartridge interface, a removable memory (for example, a flash memory or other removable memory module) and memory slot, a PCMCIA slot and card, and other fixed or removable storage units 1222 and interfaces 1220 that allow software and data to be transferred from the storage unit 1222 to computing module 1200.

Computing module 1200 might also include a communications interface 1224. Communications interface 1224 might be used to allow software and data to be transferred between computing module 1200 and external devices. Examples of communications interface 1224 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 1224 might typically be carried on signals, which can be electronic, electromagnetic (which includes optical) or other signals capable of being exchanged by a given communications interface 1224. These signals might be provided to communications interface 1224 via a channel 1228. This channel 1228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1208, storage unit 1220, media 1214, and channel 1228. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1200 to perform features or functions of the present application as discussed herein.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the application, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

While various embodiments of the present disclosure have been described above, it should be understood that they have been presented by way of example only, and not of limitation. Likewise, the various diagrams may depict an example architectural or other configuration for the disclosure, which is done to aid in understanding the features and functionality that can be included in the disclosure. The disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present disclosure. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosure, whether or not such embodiments are described and whether or not such features are presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

We claim:

1. A toy, comprising:
a housing in the shape of a videogame character, the housing having an internal cavity enclosing electronic circuitry, the electronic circuitry comprising:
a sensor to detect a housing orientation and a housing position relative to a gaming zone, and to generate a first signal indicative of the housing orientation and the housing position relative to the gaming zone;
a processor to receive the first signal and cause a transceiver to transmit a second signal indicative of the housing orientation and the housing position;
a memory;
a feedback component to provide an audible sound responsive to the occurrence of a videogame event;
a power source to supply power to the sensor, the processor, the transceiver, the electronic storage medium, and the feedback component;
wherein transmission of the second signal causes a first event to occur in a videogame running on the gaming console;
wherein the transceiver is arranged to receive a third signal from the gaming console, the third signal generated by the gaming console responsive to a second event occurring in the videogame, the second event caused by an action of a different videogame character;
wherein the processor causes the feedback component to generate an audible sound indicative of an effect of the second event on the videogame character associated with the toy;
further wherein the gaming zone is defined based on a path in space along which the housing moved during a videogame setup procedure, the path in space detected by the sensor and stored in a memory coupled with the housing.

2. A toy, comprising:
a housing having a surface portion that represents a character of a videogame;
a sensor circuit to detect one or more of a housing location relative to a gaming zone and a housing orientation relative to the gaming zone, and to generate a first signal indicative of one or more of the housing location and the housing orientation;
a communications circuit to transmit and receive wireless signals between the toy and one or more of a smartphone, a tablet, a gaming console, and a second toy;
a processing engine to interpret the first signal and responsively cause the communication circuit to transmit a second signal indicative of one or more of the housing location and housing orientation to one or more of the smartphone, the tablet, the gaming console, and the second toy;
wherein transmission of the second signal causes a change in an operation of a videogame running on one or more of the smartphone, the tablet, and the gaming console;
wherein the gaming zone is defined based on a path in space along which the housing was moved during a videogame setup procedure, the path in space detected by the sensor circuit and stored in a memory coupled with the housing.

3. The toy of claim 2, wherein the communications circuit receives a third signal from one or more of the smartphone, the tablet, the gaming console, and the second toy, the third signal associated with a videogame event;
wherein the processing engine is further arranged to cause a feedback component to generate one or more of an audible sound, a visible light, and a haptic vibration responsive to one or more of the first signal, the second signal, and the third signal.

4. The toy of claim 3, wherein the feedback component is a light-emitting diode, and the light emitting diode changes colors based on a changing game status of the toy.

5. The toy of claim 3, wherein the feedback component is a speaker, and the speaker conveys audible messages based on a changing game status of the toy.

6. The toy of claim 4, wherein the game status of the toy is associated with one or more of the corresponding videogame character's: life, death, punishment, rank, win, loss, points, energy level, earned rewards, achievement, health condition, speed, exposure to danger, and proximity to safety.

7. The toy of claim 5, wherein the game status of the toy is associated with one or more of the corresponding videogame character's: life, death, punishment, rank, win, loss, points, energy level, earned rewards, achievement, health condition, speed, exposure to danger, and proximity to safety.

8. The toy of claim 2, wherein the communications circuit is arranged for radio frequency bidirectional wireless communication.

9. The toy of claim 2, wherein the communications circuit is arranged for Bluetooth Low Energy bidirectional wireless communication.

10. The toy of claim 3, wherein the gaming zone is defined as the user moves the toy along a boundary of the desired gaming zone and the processor responsively causes the locations detected by the sensor circuit to be tracked and recorded in a memory.

11. A system, comprising:
a gaming console;
a gaming controller;
a plurality of toys, each toy comprising:
a housing having a surface portion that represents a character of a videogame;
a sensor circuit to detect one or more of a housing location relative to a gaming zone and a housing orientation relative to the gaming zone, and to generate a first signal indicative of one or more of the housing location and the housing orientation;
a communications circuit to transmit and receive wireless signals between the toy and one or more of the gaming console, the gaming controller, and other ones of the plurality of toys;
a processing engine to interpret the first signal and responsively cause the communication circuit to transmit a second signal indicative of one or more of the housing location and housing orientation to one or more of the gaming console, the gaming controller, and other ones of the plurality of toys;
wherein transmission of the second signal causes a change in an operation of a videogame running on one or more of the smartphone, the tablet, and the gaming console;
wherein the gaming zone is defined based on a path in space along which the housing was moved during a videogame setup procedure, the path in space detected by the sensor circuit and stored in a memory coupled with the housing.

12. The system of claim 11, wherein the communications circuit is further arranged to receive a third signal from one or more of the gaming console, the gaming controller, and other ones of the plurality of toys; and
wherein the processing engine is further arranged to interpret the third signal and cause a feedback component to generate one or more of an audible sound, a visible light, and a haptic vibration responsive to one or more of the first signal, the second signal, and the third signal.

13. The toy of claim 12, wherein the feedback component is a light-emitting diode, and the light emitting diode changes colors based on a changing game status of the toy.

14. The toy of claim 12, wherein the feedback component is a speaker, and the speaker conveys audible messages based on a changing game status of the toy.

15. The toy of claim 13, wherein the game status of the toy is associated with one or more of the corresponding videogame character's: life, death, punishment, rank, win, loss, points, energy level, earned rewards, achievement, health condition, speed, exposure to danger, and proximity to safety.

16. The toy of claim 14, wherein the game status of the toy is associated with one or more of the corresponding videogame character's: life, death, punishment, rank, win, loss, points, energy level, earned rewards, achievement, health condition, speed, exposure to danger, and proximity to safety.

17. The toy of claim 11, wherein the communications circuit is arranged for radio frequency bidirectional wireless communication.

18. The toy of claim 11, wherein the communications circuit is arranged for Bluetooth Low Energy bidirectional wireless communication.

19. The toy of claim 11, wherein the housing location is one or more of a relative location with respect to a prior location, a geospatial location, a relative location with respect to a base portal, and a relative location with respect to a gaming zone.

20. The toy of claim 12, wherein the gaming zone is defined as the user moves the toy along a boundary of the desired gaming zone and the processor responsively causes the locations detected by the sensor circuit to be tracked and recorded in a memory.

21. A method comprising:
determining a physical condition of a toy based on a movement detected by a sensor circuit physically coupled to the toy, wherein the toy is associated with a videogame character and the physical condition is one or more of a location and an orientation relative to a predefined gaming zone;
transmitting, from a communications circuit coupled to the toy, information indicative of the determined physical condition to a gaming console with which the toy is communicatively coupled;
receiving, at the communications circuit, information indicative of a changed gaming condition associated with a videogame character associated with the toy, the changed gaming condition based on a videogame event affecting the videogame character;
emitting, from a feedback component coupled to the toy, one or more of an audible sound or a visible light responsive to the changed gaming condition.

22. The method of claim 21, wherein information indicative of a changed gaming condition is based on one or more changed physical conditions of other toys participating in the videogame;

23. The method of claim 21, wherein the gaming zone is not defined by a base portal.

24. The method of claim 21, wherein the gaming zone is defined by a path the toy moved along during a videogame setup procedure.

25. The method of claim 21, wherein the gaming zone is defined by a boundary that is at least partially based upon a path the toy moved along during a videogame setup procedure.

26. The method of claim 21, wherein information indicative of a changed gaming condition is based on one or more of the videogame character's: life, death, punishment, rank, win, loss, points, energy level, earned rewards, achievement, health condition, speed, exposure to danger, and proximity to safety.

27. A method comprising:
determining a physical condition of a toy based on a movement detected by a sensor circuit physically coupled to the toy, wherein the toy is associated with a videogame character and the physical condition is one or more of a location and an orientation relative to a predefined gaming zone;
transmitting, from a communications circuit coupled to the toy, information indicative of the determined physical condition to a gaming console with which the toy is communicatively coupled;
receiving, at the communications circuit, information indicative of a recommended action to be performed with the toy based on a videogame event associated with a videogame character associated with the toy;
emitting, from a feedback component coupled to the toy, one or more of an audible sound or a visible light responsive to communicate the recommended movement to the user.

28. The method of claim 27, wherein the recommended action is one or more of a physical displacement of the toy to a location different from its current location, a physical rotation of the toy relative to its current orientation, a physical maneuver of the toy associated with a videogame character maneuver.

29. The method of claim 27, further comprising:
detecting, by the sensor circuit physically coupled to the toy, that the recommended action has been performed with the toy;
transmitting, from the communications circuit coupled to the toy, information indicative of the performed action to the gaming console with which the toy is communicatively coupled;
wherein a videogame operation is executed based on the transmitted information indicative of the recommended action performed by the toy.
